(19) United States
(12) Patent Application Publication
(10) Pub. No.: US 2022/0303619 A1
(43) Pub. Date: Sep. 22, 2022

(54) AUTOMATED CUSTOMIZATION OF MEDIA CONTENT BASED ON INSIGHTS ABOUT A CONSUMER OF THE MEDIA CONTENT

(71) Applicant: Daniel L. Coffing, Fairfax, VA (US)

(72) Inventor: Daniel L. Coffing, Fairfax, VA (US)

(21) Appl. No.: 17/697,578

(22) Filed: Mar. 17, 2022

Related U.S. Application Data
(60) Provisional application No. 63/162,328, filed on Mar. 17, 2021.

(51) Int. Cl. H04N 21/442; H04N 21/45; H04N 21/845; H04N 21/466; G06N 20/00

(52) U.S. Cl. CPC H04N 21/44222; H04N 21/4532; H04N 21/845; H04N 21/466; G06N 20/00

(57) ABSTRACT

A media content control system receives information about a user, who may be a consumer (e.g., a viewer, reader, and/or listener) of media content. The media content control system can analyze the information about the user to determine insights, which may for instance be related to demographics, sentiment, social networks, beliefs, interactions, history, reputation, body language, expressed reactions, and/or analysis of other similar users. The media content control system can automatically generate customized media content based on the insights determined about the user, for instance by selecting a subset of media content segments to output to the user based on the insights, and by selecting an order in which the selected media content segments are to be output to the user. The media content control system can output the customized media content to the user's user device, in some cases also based on the insights.

### CROSS-REFERENCE TO RELATED APPLICATIONS

The present application claims the priority benefit of U.S. provisional application 63/162,328 filed Mar. 17, 2021 and entitled “Automated Customization of Media Content Based on a Consumer of the Media Content,” the disclosure of which is incorporated herein by reference.

### BACKGROUND OF THE INVENTION

### 1. Field of the Invention

The present application relates to automated customization of media content. In particular, the present invention relates to automated customization of media content based on information determined about a consumer (e.g., a viewer, reader, and/or listener) of the media content.

### 2. Description of the Related Art

Human beings regularly engage in persuasive discourse across various types of media. In traditional forms of media content delivery, entities constructing and/or delivering media content are unaware of who the consumers of the media content are. For instance, entities constructing and/or delivering media content are unaware of the internal motivations of consumers of the content. Thus, traditionally, media content is prepared in a generic format. This unawareness of baseline motivations may cause the media content to “talk past” the media consumer, and greatly reduces the efficiency of communication.

Thus, there is a need for improved media content construction and delivery.

### SUMMARY OF THE CLAIMS

A system and method are provided for customizing media content.

According to one example, a method of automated media content customization is provided. The method includes: storing a plurality of media content segments; receiving information about a user; identifying an insight about the user based on an analysis of the information about the user; constructing a customized media content dataset by arranging at least a subset of the media content segments in a order, wherein the subset and the order are based on the insight about the user; and outputting, to a user device associated with the user, the customized media content dataset.

According to another example, a method of automated media content customization is provided. The method includes: storing a plurality of media content segments; outputting, to a user device associated with a user, a first media content segment of the plurality of media content segments; receiving information about the user; identifying an insight about the user based on an analysis of the information about the user; selecting, based on the insight about the user, a second media content segment of the plurality of media content segments; and outputting, to the user device associated with the user, the second media content segment following the first media content segment

### BRIEF DESCRIPTION OF THE DRAWINGS

FIG. 1 is a block diagram illustrating an architecture of an example media control system.

FIG. 2 is a conceptual diagram illustrating construction of a customized media content dataset by arranging selected media content segments in a particular order that is selected based on determinations about a media content consumer.

FIG. 3 is a conceptual diagram illustrating customized media content construction and delivery based on an analysis of a user.

FIG. 4 is a flow diagram illustrating a process for automated constructing and outputting a customized media dataset based on an insight about a user.

FIG. 5 is a flow diagram illustrating a process for automated customized outputting media content segments based on an insight about a user.

FIG. 6 is a system diagram of an exemplary computing system that may implement various systems and methods discussed herein, in accordance with various embodiments of the subject technology.

### DETAILED DESCRIPTION

Embodiments of the present invention may include systems and methods for media content customization. A media control system can receive information about a user. The user may be a media content consumer who is consuming media content, for instance by watching the media content, listening to the media content, reading the media content, or a combination thereof. The user may be preparing to consume media content, for example by scrolling through a media content selection interface associated with the media control system. The media content that the user is consuming or preparing to consume may be from may be constructed and/or delivered by the media control system. The media control system may include, for example, a streaming video delivery website or application, a locally-stored video delivery website or application, a streaming music website or application, a locally-stored music delivery website or application, an audiobook delivery website or application, an ebook reading website or application, a news website or application, a chat website or application, a debate website or application, another user-to-user discourse website or application, or a combination thereof.

The user may be consuming the media content through a user device associated with the user. The media control system may construct the media content and/or deliver the media content to the user device. The media control system may receive information about the user from the user device and/or from portions of the media control system (e.g., an interface layer of the media control system). The media control system may generate insights about the user based on analysis of the information about the user. The information and/or insights may include, for example, demographic information about the user, one or more sentiments of the user, social network connections of the user, beliefs of the user, interactions between the user and content interfaces, historical data about the user, a reputation of the user, body language of the user, expressed reactions of the user, information about other users, information about similar users to the user, or combinations thereof. The media control system can construct customized media content based on the information and/or insights about the user, for example by selecting specific media content segments to include in the customized media content and/or arranging the selected media content segments in a particular order in the customized media content. The media control system can deliver the customized media content to the user device of the user in a customized manner.

The systems and methods for media content customization described herein can provide technical improvements to communication, media content generation, and media content delivery technologies and systems. Technical improvements include, for instance, improved customization of media content and media content delivery that is personalized based on user information and/or insights.

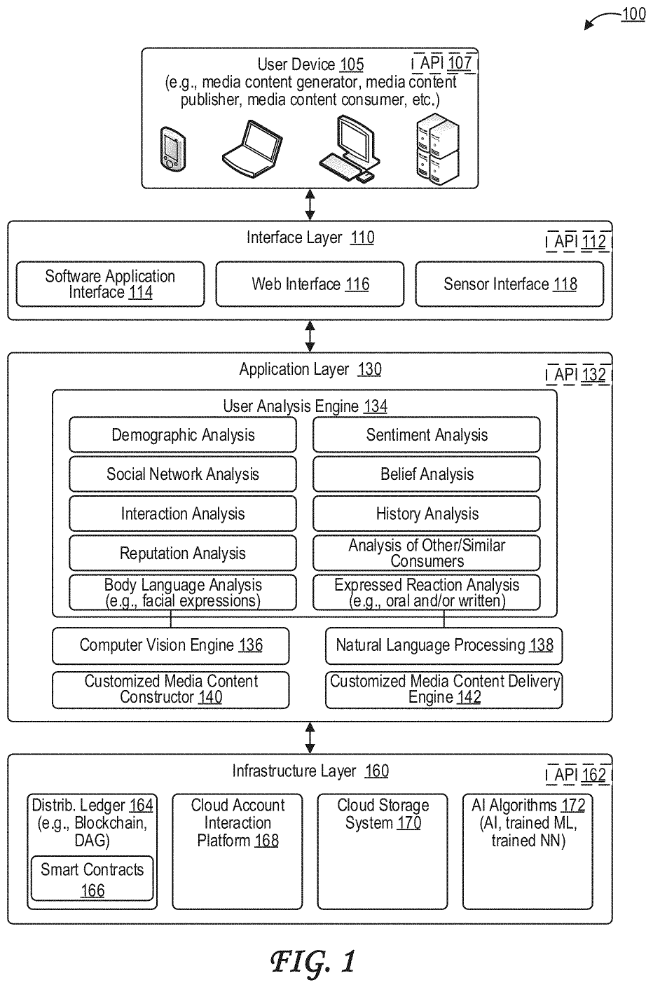

FIG. 1 is a block diagram illustrating an architecture of an example media control system 100. The architecture of the media control system 100 includes three layers—an interface layer 110, an application layer 130, and an infrastructure layer 160. The interface layer 110 generates and/or provides one or more interfaces that user devices 105 interact with. The interface layer 110 can receive one or more inputs from user devices 105 through the one or more interfaces. The interface layer 110 can receive content from the application layer 130 and/or the infrastructure layer 160 and output (e.g., display) the content to the user device 105 through the one or more interfaces.

The one or more interfaces can include graphical user interfaces (GUIs) and other user interfaces (UIs) that the user device 105 directly interacts with. The one or more interfaces can include interfaces directly with software running on the user device 105, for example interfaces that interface with an application programming interface (API) 107 of software running on the user device 105 and/or hardware of the user device 105 (e.g., one or more sensors of the user device 105). The one or more interfaces can include interfaces with software running on an intermediary device between the media control system 100 and the user device 105, for example interfaces that interface with an application programming interface (API) of software running on the intermediary device. The intermediary device may be, for example, a web server (not pictured) that hosts and/or serves a website to the user device 105, where the web server provides inputs that the web server receives from the user device 105 to the media control system 100.

The one or more interfaces generated and/or managed by the interface layer 110 may include a software application interface 114, a web interface 116, and/or a sensor interface 118. The software application interface 114 may include interfaces for one or more software applications that run on the user device 105. For instance, the software application interface 114 may include an interface that calls an API of (or otherwise interacts with) a software application that runs on (or that is configured to run on) on the user device 105. In some cases, the software application may be a mobile app, for instance where the user device 105 is a mobile device. The software application interface 114 may include interfaces for one or more software applications that run on an intermediate device between the user device 105 and the media control system 100. For instance, the software application interface 114 may include an interface that calls an API 107 of (and/or otherwise interacts with) the user device 105 and/or of one or more software applications that run on (and/or that are configured to run on) on the intermediate device.

The web interface 116 can include a website. The web interface 116 may include one or more forms, buttons, or other interactive elements accessible by the user device 105 through the website. The web interface 116 may include an interface to a web server, where the web server actually hosts and serves the website, and provides inputs that the web server receives from the user device 105 to the media control system 100. For instance, the web interface 116 may include an interface that calls an API of (or otherwise interacts with) the web server. The web server may be remote from the media control system 100.

The sensor interface 118 can include a communicative connection and/or communicative coupling to one or more sensors of the user device 105, one or more sensors of the media control system 100, or a combination thereof. The sensor interface 118 can receive one or more sensor datasets captured by one or more sensors of the user device 105. The one or more sensors of the user device 105 can include, for example, one or more cameras, one or more facial scanners, one or more infrared (IR) sensors, one or more light detection and ranging (LIDAR) sensors, one or more radio detection and ranging (RADAR) sensors, one or more sound detection and ranging (SODAR) sensors, one or more sound navigation and ranging (SONAR) sensors, one or more neural interfaces (e.g., brain implants and/or neural implants), one or more touch sensors (e.g., of a touchscreen or touchpad or trackpad), one or more pressure sensors, one or more accelerometers, one or more gyroscopes, one or more inertial measurement units (IMUs), one or more button press sensors, one or more sensors associated with positioning of a mouse pointer, one or more keyboard/keypad button press sensors, one or more current sensors, one or more voltage sensors, one or more resistance sensors, one or more impedance sensors, one or more capacitance sensors, one or more network traffic sensors, or a combination thereof.

In some examples, the interface layer 110 may include an API 112 that can trigger performance of an operation by the interface layer 110 in response to being called by the application layer 130, the infrastructure layer 160, the user device 105, the above-described web server, another computing system 600 that is remote from the media control system 100, or another device or system described herein. Any of the operations described herein as performed by the interface layer 110 may be performed in response to a call of the API 112 by one of the devices or systems listed above.

The infrastructure layer 160 can include a distributed ledger 164 that stores one or more smart contracts 166. The distributed ledger 164 may be decentralized, stored, and synchronized among a set of multiple devices. The distributed ledger 164 may be public or private. In some examples, the distributed ledger 164 may be a blockchain ledger. For instance, the blockchain ledger may an Ethereum blockchain ledger. In some examples, the distributed ledger 164 may be a directed acyclic graph (DAG) ledger. Each block of the distributed ledger may include a block payload (e.g., with transactions and/or smart contracts 166) and/or a block header. The block header may include a hash of one or more previous blocks, a Merkle root of the blocks of the distributed ledger (before or after addition of the block itself), a nonce value, or a combination thereof.

The infrastructure layer 160 can include a cloud account interaction platform 168. The cloud account interaction platform 168 may allow different users, such as users associated with user devices 105, to create and manage user accounts. The cloud account interaction platform 168 can allow one user using one user account to communicate with another user using another user account, for example by sending a message or initiating a call between the two users through the cloud account interaction platform 168. The user accounts may be tied to financial accounts, such as bank accounts, credit accounts, gift card accounts, store credit accounts, and the like. The cloud account interaction platform 168 can allow one user using one user account to transfer funds or other assets from a financial account associated with their user account to or from another financial account associated with another user using another user account. In some examples, the cloud account interaction platform 168 processes the transfer of funds by sending a fund transfer message to a financial processing system that performs the actual transfer of funds between the two financial accounts. The fund transfer message can, for example, identify the two financial accounts and an amount to be transferred between the two financial accounts.

The infrastructure layer 160 can include a cloud storage system 170. The cloud storage system 170 can store information associated with a user account of a user associated with a user device 105. In some examples, the cloud storage system 170 can store a copy of a media content dataset, a media content segment, or another type of media asset. For instance, the cloud storage system 170 can store an article, an image, a television segment, a radio segment, one or more portions thereof, or a combination thereof. In some examples, the cloud storage system 170 can store a smart contract of the smart contracts 166, while the distributed ledger 164 stores a hash of the smart contract instead of (or in addition to) storing the entire smart contract. In some examples, the cloud storage system 170 can store a copy of at least a portion of the distributed ledger 164.

The infrastructure layer 160 can include one or more artificial intelligence (AI) algorithms 172. The one or more AI algorithms 172 can include AI algorithms, trained machine learning (ML) models based on ML algorithms and trained using training data, trained neural networks (NNs) based on NN algorithms and trained using training data, or combinations thereof. The one or more trained NNs can include, for example, convolutional neural networks (CNNs), recurrent neural networks, feed forward NNs, time delay neural networks (TDNNs), perceptrons, or combinations thereof.

In some examples, the infrastructure layer 160 may include an API 162 that can trigger performance of an operation by the infrastructure layer 160 in response to being called by the interface layer 110, the application layer 130, the user device 105, the above-described web server (not pictured), another computing system 600 that is remote from the media control system 100, or another device or system described herein. Any of the operations described herein as performed by the infrastructure layer 160 may be performed in response to a call of the API 162 by one of the devices or systems listed above.

The application layer 130 may include a user analysis engine 134. The user analysis engine 134 may analyze information about a user of the user device 105 and/or may generate insights about the user of the user device 105. For example, the user analysis engine 134 can receive information about the user from the user device 105, (e.g., through the interface layer 110), from the interface layer itself, from analyses performed at the application layer 130 and/or infrastructure layer 160, or a combination thereof. The user analysis engine 134 generate insights about the user of the user device 105 based on the information about the user of the user device 105. The user of the user device 105 can be a media content consumer who is consuming media content, for instance by watching the media content, listening to the media content, reading the media content, or a combination thereof. The user of the user device 105 may be preparing to consume media content, for example by scrolling through a media content selection interface on the user device 105. The media content selection interface can be generated by the interface layer 110 of the media control system 100. For instance, the media content selection interface can be generated by the web interface 116 if the media content selection interface is on a website, or can be generated by the software application interface 114 if the media content selection interface is part of a software application.

The user analysis engine 134 can perform a demographic analysis, in which case the insights generated by the user analysis engine 134 can include demographic information about the user. Demographic information may include, for example, the user's name, surname, age, sex, gender, race, ethnicity, mailing address, residence address, political party registration, job title, or a combination thereof. Demographic analysis results may be useful for the customized media content constructor 140 to customize content based on media that historically appeals to users with the same sex, the same ethnicity, the same job title, that live in the same area, the same political party registration and so forth. In some cases, demographic information can also include a user's level of education (e.g., schooling) and/or a user's level of expertise on particular topics (e.g., related to education and/or work and/or training), a user's sophistication, and so forth. Such information may be useful to the customized media content constructor 140 to customize content based on education, expertise, and/or sophistication. For example, if the user reports that they have a PhD in chemistry, the customized media content constructor 140 can skip over media content segments explaining very basic chemistry concepts, instead getting right into the cutting-edge chemistry details in the media. In some examples, demographic information can also include a user's personality, and values along spectra for aspects such as openness, conscientiousness, extraversion, agreeableness, neuroticism, introversion, thinking, feeling, sensing, intuition, judgment, perceiving, or combinations thereof. Such information may be useful to the customized media content constructor 140 to customize content based on the user's identified personality traits, and/or based on media that historically appeals to users with the user's identified personality traits. In some cases, demographic information can also include a user's known illnesses or handicaps. Such information may be useful to the customized media content constructor 140 to customize content based on those illnesses or handicaps. For example, if the user reports that they are deaf, the media can be customized to be primarily visual; if the user reports that they are blind, the media can be customized to be primarily audio-based; if the user reports that they have a memory-related illness (e.g., Alzheimers) or an attention-related issue (e.g., attention deficit disorder), the media can be customized for conciseness.

The user analysis engine 134 can perform a sentiment analysis, in which case the insights generated by the user analysis engine 134 can include one or more sentiments expressed by the user and/or likely to be felt by the user. Sentiment information may include, for example, indications that the user may be happy, sad, anxious, in a hurry, tired, confused, bored, lazy, angry, upset, or a combination thereof. Sentiment analysis results may be useful for the customized media content constructor 140 to customize content based on media that historically appeals to users experiencing similar sentiments. For instance, the customized media content constructor 140 can customize the customized media content to use more soothing colors, background music, images, and/or phrases if the user is stressed or upset. The customized media content constructor 140 can customize the customized media content to use more energetic or aggressive colors, background music, images, and/or phrases if the user is excited, happy, or angry.

The user analysis engine 134 can perform a social network analysis, in which case the insights generated by the user analysis engine 134 can include one or more social network connections associated with the user. Social network connections may include, for example, indications that the user is connected to a second user through an online social networking website or application (e.g., Facebook, Linkedin, Instagram, Whatsapp, etc.), indications that the user has a second user's contact information (e.g., phone number, email, username on a messaging service) stored on the user device 105, indications that the user and a second user are family, indications that the user and a second user are friends, indications that the user and a second user are in a relationship, indications that the user and a second user are co-workers, indications that the user knows a second user personally (e.g., in the real world), or a combination thereof. Social network analysis may generate a social graph graphing the various interconnected nodes and groups of the user's social network(s). Social network analysis results may be useful for the customized media content constructor 140 to customize content based on other users that the user knows. For instance, the customized media content constructor 140 can customize the customized media content to identify, to the user, other users in the user's network who have performed a task that the customized media content is promoting to the user. The customized media content constructor 140 can customize the customized media content to use terms, phrases, images, audio, music, and/or other media content that other users in the user's network have found persuasive.

The user analysis engine 134 can perform a belief analysis, in which case the insights generated by the user analysis engine 134 can include one or more beliefs of the user. Beliefs may include, for example, indications of the user's religious beliefs, political beliefs, likes, dislikes, preferences, or combinations thereof. Belief analysis results may be useful for the customized media content constructor 140 to customize content based on the user's beliefs and/or based on media that historically appeals to users with the same beliefs.

The user analysis engine 134 can perform an interaction analysis, in which case the insights generated by the user analysis engine 134 can include one or more interactions between the user and one or more aspects of the interface layer 110. For example, the one or more interactions may include indications as to whether the user has indicated that the user likes the media content, whether the user has disliked the media content, whether the user identified an indication of their reaction (e.g., happy, angry, sad) to the media content through the interface layer 110, whether the user has shared the media content with a second user, whether the user has shared the media content through a social networking website or application, whether the user has commented on the media content, whether the user has challenged or critiqued the media content, or a combination thereof. Information about interactions may be useful for the customized media content constructor 140 to customize content based on what the user has shown to be effective for the user based on the interactions themselves (e.g., what the user has shown that they “like” based on the interactions themselves). Information about interactions may be useful for the customized media content constructor 140 to customize content based on media that historically appeals to users that perform similar interactions.

The user analysis engine 134 can perform a history analysis, in which case the insights generated by the user analysis engine 134 can include historical data associated with the user. Historical data associated with the user may include, for example, other media content that the user has previously consumed, liked, shared, commented on, or otherwise interacted with as discussed in the preceding paragraph. Historical data about a user may be useful for the customized media content constructor 140 to customize content to be more similar to media that the user has historically consumed, enjoyed, and/or found persuasive. Historical data about a user may be useful for the customized media content constructor 140 to customize content based on media that historically appeals to users with similar histories.

The user analysis engine 134 can perform a reputation analysis, in which case the insights generated by the user analysis engine 134 can include a reputation score associated with the user. A reputation score may be based on, for example, the user's reputation for veracity, truth, logical argumentation, persuasiveness, fairness, positivity, negativity, falsehoods, lying, illogical argumentation, unfairness, or combinations thereof. In some examples, users may challenge media content that they consume, for example by challenging veracity, truth, logic, fairness, or persuasiveness of the media content. If the user's challenge has merit (e.g., as determined by other users, the user analysis engine 134, or a combination thereof), then the user's reputation score can increase. If the user's challenge does not have merit (e.g., as determined by other users, the user analysis engine 134, or a combination thereof), then the user's reputation score can decrease. The user can further generate and/or distribute content themselves. If the user's own content scores highly on veracity, truth, logic, fairness, and/or persuasiveness (e.g., as determined by other users, the user analysis engine 134, or a combination thereof), then the user's reputation score can increase. If the user's own content scores poorly on veracity, truth, logic, fairness, and/or persuasiveness (e.g., as determined by other users, the user analysis engine 134, or a combination thereof), then the user's reputation score can decrease.

In some examples, the user may be asked (e.g., via the interface layer 110, in some examples with monetary or reputation incentives) to challenge or critique media content indicative of a perspective that the user believes, prefers, or sympathizes with. If the user provides an honest and high-quality challenge or critique of the media content (e.g., as determined by other users, the user analysis engine 134, or a combination thereof), then the user's reputation score can increase. If the user fails to provide an honest and high-quality challenge or critique of the media content (e.g., as determined by other users, the user analysis engine 134, or a combination thereof), then the user's reputation score can decrease. In some examples, the user may asked (e.g., via the interface layer 110, in some examples with monetary or reputation incentives) to provide persuasive arguments for positions that information about the user indicates that the user does not support and/or is actively against. If the user provides an honest and high-quality persuasive argument for the position (e.g., as determined by other users, the user analysis engine 134, or a combination thereof), then the user's reputation score can increase. If the user fails to provide an honest and high-quality persuasive argument for the position (e.g., as determined by other users, the user analysis engine 134, or a combination thereof), then the user's reputation score can decrease.

In some examples, the reputation analysis results indicate a set of user values and/or values of the user's peers and/or members of their social networks. Another use of the reputation analysis element is that, if a user has a high reputation value (e.g., exceeding a threshold) as determined by the user analysis engine 134, the user is likely to also have a high reputation with the members of the high-reputation user's social network(s). The customized media content constructor 140 to customize content for users in the high-reputation user's social network(s) based on content that the high-reputation user has historically consumed, enjoyed, and/or found persuasive. The customized media content constructor 140 to customize content for users in the high-reputation user's social network(s) based on content that historically appeals to the high-reputation user and/or similar users.

The user analysis engine 134 can perform a body language analysis, in which case the insights generated by the user analysis engine 134 can include one or more recognized body language expressions of the user. Body language expressions may include facial expressions, such as smiles, frowns, confused expressions, yawns, or combinations thereof. Body language expressions may include indications of where the user is looking, pointing, or touching. Body language expressions may include expressions using other parts of the body than the face, such as crossed arms, slouched posture, straight posture, open posture, closed posture, or combinations thereof. Body language expressions may for example be used as part of sentiment analysis, for instance to identify that the user is sad based on the user crying, frowning, having their arms crossed, having their posture slouched, having their posture closed, or a combination thereof. Similarly, body language expressions may for example be used as part of sentiment analysis to identify that the user is happy based on the user smiling, laughing, having their posture straight, having their posture open, or a combination thereof. Body language analysis may be determined by the application layer based on a computer vision engine 136.

The computer vision engine 136 may use camera data from the user device 105, which may be obtained by the computer vision engine 136 through the sensor interface 118. In some examples, the computer vision engine 136 may perform feature detection, feature recognition, feature tracking, object detection, object recognition, object tracking, facial detection, facial recognition, facial tracking, body detection, body recognition, body tracking, expression detection, expression recognition, expression tracking, or a combination thereof. The computer vision engine 136 may be powered by the AI algorithms 172, such as computer vision AI algorithms, trained computer vision ML models, trained computer vision NNs, or a combination thereof.

The user analysis engine 134 can perform an expressed reaction analysis, in which case the insights generated by the user analysis engine 134 can include identify the user's reaction based on the user's oral reaction to the media content (e.g., obtained through a microphone of the user device 105 via the sensor interface 118), the user's written reaction to the media content (e.g., in written comments about the media content), or a combination thereof. Depending on what the user verbalizes or writes, the expressed reaction analysis can be used to obtain information used in the demographic analysis, the sentiment analysis, the social network analysis, the belief analysis, the interaction analysis, the history analysis, the reputation analysis, or a combination thereof. For instance, the user may reveal information about themselves in their oral or written expressed reaction(s). The user's oral reactions may be converted into text via a speech recognition algorithm, a speech-to-text algorithm, or a combination thereof. The user's written reactions, as well as the user's oral reactions (once they have been converted into text), can by analyzed using a natural language processing engine 138. The natural language processing engine 138 may be powered by the AI algorithms 172, such as computer vision AI algorithms, trained computer vision ML models, trained computer vision NNs, or a combination thereof.

The user analysis engine 134 can perform an analysis based on other users. The user analysis engine 134 can perform an analysis based on other users that are determined to be similar to the user. The user analysis engine 134 can determined that other users are similar to the user based on shared or similar demographic information, shared or similar sentiments in relation to media content, shared or similar social network connections, shared or similar beliefs, shared or similar interactions in relation to media content, shared or similar history in relation to media content, shared or similar reputation score, shared or similar body language in relation to media content, shared or similar expressed reactions in relation to media content, or a combination thereof. If the user analysis engine 134 determines that another user is similar to the user based on any of the above, the user analysis engine 134 can in some cases use this as an indication that the user may share other similarities with the other user, for example with respect to demographic information, sentiments in relation to media content, social network connections, beliefs, interactions in relation to media content, history in relation to media content, reputation score, body language in relation to media content, expressed reactions in relation to media content, or a combination thereof.

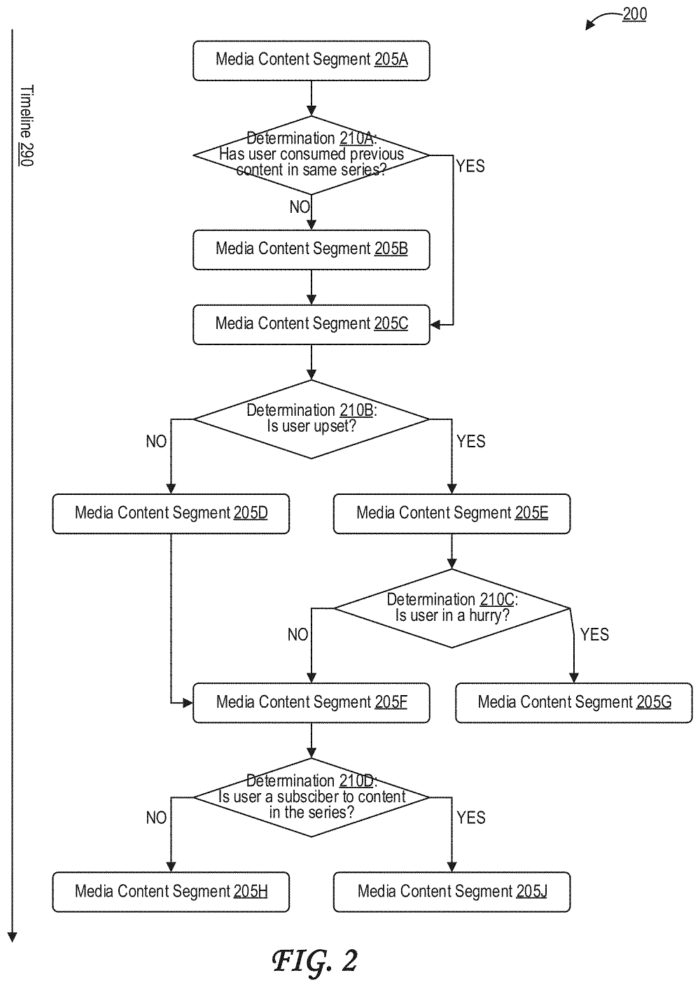

The application layer 130 may include a customized media content constructor 140. The customized media content constructor 140 can construct customized media content based on user information collected using the interface layer and/or the user analysis engine 134, and/or based on insights generated based on the user information. The customized media content constructor 140 can generate the customized media content by selecting at least a subset of a plurality of possible media content segments to present to the user based on the user information and/or the user insights. The customized media content constructor 140 can generate the customized media content by arranging the selected media content segments in a particular order to present to the user. Examples of selection of media content segments and arranging of selected media content segments in a particular order are illustrated in FIG. 2. The customized media content constructor 140 can generate the customized media content by editing certain words, phrases, images, audio segments, or video segments within the selected media content segments based on the user information and/or the user insights. For example, if an insight from the user analysis engine 134 indicates that the user considers a certain word or phrase offensive, the customized media content constructor 140 can edit the customized media content to replace an instance of the offensive word or phrase with an inoffensive or less offensive word or phrase. Similarly, if an insight from the user analysis engine 134 indicates that the user is from a particular region, the customized media content constructor 140 can edit (or “localize”) an idiom or slang term/phrase in the media content by replacing the idiom or slang term/phrase with another idiom or slang term/phrase that is local to the particular region that the user is from. For instance, the customized media content constructor 140 can edit the customized media content to say “soda,” “pop,” or “coke” depending on the user's region.

Additionally, the customized media content constructor 140 can edit the customized media content to replace certain terms, phrases, or images in the customized media content with other terms, phrases, or images that the customized media content constructor 140 selects based on the user analysis by the user analysis engine 134. For example, the customized media content constructor 140 can edit the customized media content to replace certain terms, phrases, or images in the customized media content with other terms, phrases, or images that the customized media content constructor 140 selects based on (and to match) the user's demographics, the user's sentiment, the user's social networks, the user's beliefs, the user's interactions, the user's history, the user's reputation, the user's body language, which historical references are likely to connect with the user, the user's pace in consuming content, the user's sophistication (e.g., based on education level), prior terms/phrases/images/media the user has consumed, prior terms/phrases/images/media the user has found persuasive, prior terms/phrases/images/media that other users similar to the user or connected to the user through social networks have found persuasive, color preferences of the user, aesthetic preferences of the user, emotional intensity associated with the user, degrees of explanatory material that the user is determined to be likely to need on a particular topic (e.g., based on whether or not the user has consume previous media with explanatory material about the topic), depth or choice of references, or combinations thereof.

The application layer 130 may include a customized media content delivery engine 142. The customized media content delivery engine 142 can customize delivery of the customized media content generated by the customized media content constructor 140. The customized media content that the user is consuming or preparing to consume may be delivered by the customized media content delivery engine 142 through, for example, a streaming video delivery website or application, a locally-stored video delivery website or application, a streaming music website or application, a locally-stored music delivery website or application, an audiobook delivery website or application, an ebook reading website or application, a news website or application, a chat website or application, a debate website or application, another user-to-user discourse website or application, or a combination thereof. The customized media content delivery engine 142 can deliver the customized media content to the user device 105 based on content delivery options preferred by the user. For instance, if the customized media content is available in video, audio, and text format, then the customized media content delivery engine 142 can provide the customized media content to the user device 105 in video format if the user analysis engine 134 indicates that the user prefers the video format. In some examples, the customized media content delivery engine 142, the customized media content constructor 140, or a combination thereof can generate a new format of the customized media content. For instance, if the user analysis engine 134 indicates that the user is blind or otherwise prefers audio over text, the customized media content delivery engine 142 and/or the customized media content constructor 140 can generate an audio version of a text-based piece of media content, for instance using a text-to-speed algorithm powered by the AI algorithms 172.

In some examples, the application layer 130 may include an API 132 that can trigger performance of an operation by the application layer 130 in response to being called by the interface layer 110, the infrastructure layer 160, the user device 105, the web server, another computing system 600 that is remote from the media control system 100, or another device or system described herein. Any of the operations described herein as performed by the application layer 130 may be performed in response to a call of the API 132 by one of the devices or systems listed above.

The media control system 100 may include one or more computing systems 600. In some examples, the interface layer 120 includes a first set of one or more computing systems 600. In some examples, the application layer 130 includes a second set of one or more computing systems 600. In some examples, the infrastructure layer 160 includes a third set of one or more computing systems 600. In some examples, one or more shared computing systems 600 are shared between the first set of one or more computing systems 600, the second set of one or more computing systems 600, and/or the third set of one or more computing systems 600. In some examples, one or more of the above-identified elements of the interface layer 120, the application layer 130, and/or the infrastructure layer 160 may be performed by a distributed architecture of computing systems 600.

FIG. 2 is a conceptual diagram 200 illustrating construction of a customized media content dataset by arranging selected media content segments 205A-205J in a particular order that is selected based on determinations 210A-210D about a media content consumer. The construction of a customized media content dataset in FIG. 2 may be performed by the customized media content constructor 140, the customized media content delivery engine 142, or a combination thereof. The customized media content dataset can include an arrangement of media content segments 205A-205J and/or determinations 210A-210D along a timeline 290.

In the conceptual diagram 200, the customized media content dataset starts with a first media content segment 205A for all consumers of the media content. A first determination 210A is made based on received user information about the user and/or insights generated by the user analysis engine 134. The first determination 210A is a determination as to whether the user has consumed previous media content in the same series of media content (e.g., based on a history analysis by the user analysis engine 134). If the first determination 210A indicates that the user has not consumed previous media content in the same series of media content, then media content segment 205B can follow media content segment 205A. Media content segment 205C can follow media content segment 205B. If the first determination 210A indicates that the user has consumed previous media content in the same series of media content, then media content segment 205B can be skipped, and media content segment 205B can instead follow media content segment 205A. For instance, media content segment 205B can be an explanation with background information that can be skipped if the determination 210A indicates that the user has watched a previous video, read a previous book/article, and the like. The media content segment 205C is followed by a second determination 210B.

The second determination 210B is a determination as to whether the user is upset (e.g., based on a sentiment analysis, an interaction analysis, a body language analysis, and/or an expressed reaction analysis by the user analysis engine 134). If the second determination 210B indicates that the user is not upset, then the media content segment 205D can follow the media content segment 205C. The media content segment 205F can follow the media content segment 205D. If the second determination 210B indicates that the user is upset, then the media content segment 205E can follow the media content segment 205C. The media content segment 205E is followed by a third determination 210C.

The third determination 210C is a determination as to whether the user is in a hurry (e.g., based on a sentiment analysis, an interaction analysis, a body language analysis, and/or an expressed reaction analysis by the user analysis engine 134). If the third determination 210C indicates that the user is in a hurry, then the media content segment 205G can follow the media content segment 205E, and the media content segment 205G can be the final part of the customized media content dataset. If the third determination 210C indicates that the user is not in a hurry, then the media content segment 205F can follow the media content segment 205E. The media content segment 205F is followed by a fourth determination 210D.

The fourth determination 210D is a determination as to whether the user is a subscriber to content in the series (e.g., based on an interaction analysis, on a social network analysis, and/or on a history analysis by the user analysis engine 134). If the fourth determination 210D indicates that the user is a subscriber, then the media content segment 205H can follow the media content segment 205F, and the media content segment 205H can be the final part of the customized media content dataset. If the fourth determination 210D indicates that the user is not in a hurry, then the then the media content segment 205J can follow the media content segment 205F, and the media content segment 205J can be the final part of the customized media content dataset. For instance, the media content segment 205H can include an encouragement to the user to subscribe to the content in the series, while the media content segment 205J can thank the user for already being a subscriber to the content in the series.

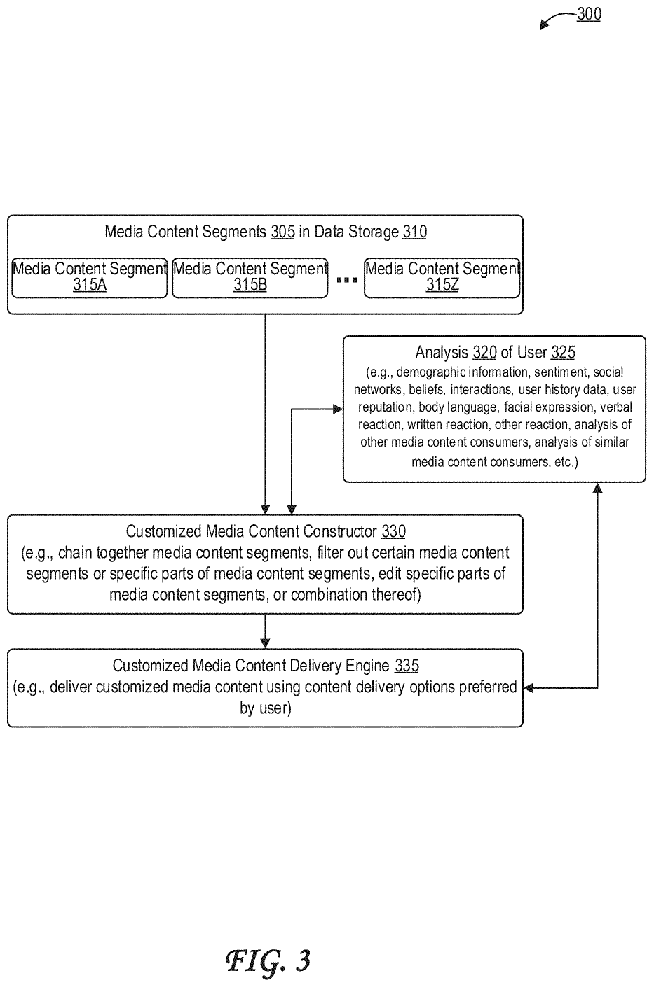

FIG. 3 is a conceptual diagram 300 illustrating customized media content construction and delivery based on an analysis 320 of a user 325. The customized media content construction is performed by a customized media content constructor 330, which constructs a customized media dataset out of media content segments 305 stored in a data storage 310. The data storage 310 may be, for example, the cloud storage system 170 of FIG. 1. The media content segments 305 include a media content segment 315A, a media content segment 315B, and so forth, all the way up to a media content segment 315Z. The customized media content constructor 330 may select a subset of the media content segments 305 based on the analysis 320 of the user 325. The customized media content constructor 330 may arrange the selected subset of the media content segments 305 in a particular order based on the analysis 320 of the user 325.

The user 325 may be an example of the user of the user device 105 of FIG. 1. The user 325 may be a media consumer and/or a user who is preparing to consume media. The analysis 320 of the user 325 may include any type of analysis discussed with respect to the user analysis engine 134, including analysis of demographic information, sentiment, social networks, beliefs, interactions, user history data, user reputation, body language, facial expression, verbal reaction, written reaction, other reaction, analysis of other media content consumers, analysis of similar media content consumers, or combinations thereof. The user 325 may be referred to as a media content consumer, as a media consumer, as a content consumer, as a viewer, as a reader, as a listener, as an audience member, as a recipient, or some combination thereof.

The customized media content constructor 330 can construct customized media content based on the analysis 320 of the user 325. The customized media content constructor 330 can generate the customized media content by selecting at least a subset of a plurality of possible media content segments to present to the user based on the analysis 320 of the user 325. The customized media content constructor 330 can generate the customized media content by arranging the selected media content segments in a particular order to present to the user based on the analysis 320 of the user 325. Examples of this are illustrated in FIG. 2.

The customized media content constructor 330 can generate the customized media content by editing certain words, phrases, images, audio segments, or video segments within the selected media content segments based on the user information and/or the user insights. Examples of this are discussed above with respect to the customized media content constructor 140 and the user analysis engine 134.

In some examples, the customized media content constructor 330 can customize media content as media content is received from a media content presenter. The customized media content can then be delivered to devices of users 325 consuming the content. In effect, this may function like a live stream from the device of the presenter to the devices of consuming users 325, with a slight delay during which customization occurs. In some examples, the customized media content constructor 330 even send suggestions or alternate content to the device of the presenter as the presenter is presenting the media content based, the suggestions or alternate content based on the analysis 320 of the users 325. The customized media content constructor 330 can automatically modify the customized media content according to insights determined through analyses 320 (e.g., indicating sentiments and/or dispositions or any other information discussed with respect to the user analysis engine 134) determined for each user 325 of multiple users 325 consuming the media at the time of consumption such that one message from a presenter of the media could be customized for each individual user 325 according to their state or sentiment at the time of their consumption. This may be true even if the consumption times and recipient sentiments were different for the different media-consuming users 325 and even if all the consumed media contents might be deemed to have an equivalent persuasive effect (EPE). EPE can include anticipated levels of impact upon or deflection to a belief held by a dialogue participant, tested responses to a corresponding subject matter of the dialogue participant (e.g., using before and after testing, A/B testing, etc.), physiological response tests (e.g., via brain scans, etc.), and the like which may provide further information to, for example customized media content constructor 330, for customizing the media content to each user.

Customized media content generated and/or customized by the customized media content constructor 330 can, in some examples, take the form of a dialogue. Dialogue participants (e.g., users 325), such as an audience or other dialogue recipient, may receive information (e.g., a presentation or dialogue) differently based on either or both of individual and group sentiment and disposition. Generally, a presenter may realize increased success (e.g., convincing an audience of a stance, informing an audience, etc.) when made aware of the sentiment and disposition of other dialogue participants. The presenter can adjust aspects of how ideas are presented in response to participant sentiment and disposition. Further, the sentiment and disposition can be used to automatically adjust dialogue submitted by the presenter (e.g., via text based medium such as email or message board, etc.) to conform to reader sentiment on either an individual (e.g., each reader receives a respectively adjusted dialogue) or group basis (e.g., all readers receive a tonally optimized dialogue).

For example, some audiences may be sympathetic (or antagonistic or apathetic) to certain group interests (e.g., social justice, economic freedom, etc.), contextual frameworks, and the like. Those in discourse with such audiences may find it advantageous to adjust word choice, framing references, pace, duration, rhetorical elements, illustrations, reasoning support models, and other aspects of a respective dialogue. In some cases, for example, it may be advantageous to engage in an inquisitive or deliberative form of dialogue, whereas in other cases (e.g., before other audiences) the same ideas and points may be more likely to be successfully conveyed in a persuasive or negotiation form of dialogue.

However, it is often difficult for a human to accurately determine the sentiment or disposition of an audience. In some cases, a person may be too emotionally invested in the content being conveyed. In other cases, it may be difficult to gauge sentiment and disposition due to audience size or physical characteristics of the space where the dialogue is occurring (e.g., the speaker may be at an angle or the like to the audience, etc.). A speaker may also be a poor judge of audience sentiment and disposition, for whatever reason, and so likely to misjudge or fail to ascertain the audience sentiment and disposition.

A three-phase process can be enacted to alleviate the above issues as well as augment intra-human persuasion (e.g., dialogue, presentation, etc.). Premises and their reasoning interrelationships may first be identified and, in some cases, communicated to a user. In a second phase, a user or users may be guided toward compliance with particular persuasive forms (e.g., avoidance of fallacies, non-sequiturs, ineffective or detrimental analogies, definition creep or over-broadening, etc.). In some examples, guidance can occur in real-time such as in a presentational setting or keyed-in messaging and the like. Further, in a third phase, guiding information can be augmented and/or supplemented with visual and/or audio cues and other information, such as social media and/or social network information, regarding members to a dialogue (e.g., audience members at a presentation and the like). It is with the second and third phases which the systems and methods disclosed herein are primarily concerned.

In some examples, static information such as, without imputing limitation, demographic, location, education, work history, relationship status, life event history, group membership, cultural heritage, and other information can be used to guide dialogue. In some examples, dynamic information such as, without imputing limitation, interaction history (e.g., with the user/communicator, regarding the topic, with the service or organization associated with the dialogue, over the Internet generally, etc.), speed of interaction, sentiment of interaction, mental state during interaction (e.g., sobriety, etc.), limitations of the medium of dialogue (e.g., screen size, auditorium seating, etc.), sophistication of participants to the dialogue, various personality traits (e.g., aggressive, passive, defensive, victimized, etc.), search and/or purchase histories, errors and/or argument ratings or histories within the corresponding service or organization, evidence cited in the past by dialogue participants, and various other dynamic factors which may be used to determine dialogue guidance.

In particular, the above information may be brought to bear in a micro-sculpted real-time communication by, for example and without imputing limitation, determining changes to be made in colloquialisms, idioms, reasoning forms, evidence types or source, vocabulary or illustration choices, or sentiment language. The determined changes can be provided to a user (e.g., a speaker, communicator, etc.) to increase persuasiveness of dialogue by indicating more effective paths of communication to achieving understanding by other dialogue participants (e.g., by avoiding triggers or pitfalls based on the above information).

In one example, visual and audio data of an audience can be processed during and throughout a dialogue. The visual and audio data may be used by Natural Language Processing (NLP) and/or Computer Vision (CV) systems and services in order to identify audience sentiment and/or disposition. CV/NLP processed data can be processed by a sentiment identifying service (e.g., a trained deep network, a rules based system, a probabilistic system, some combination of the aforementioned, or the like) which may receive analytic support by a group psychological deep learning system to identify sentiment and/or disposition of audience members. In particular, the system can provide consistent and unbiased sentiment identification based on large volumes of reference data.

Identified sentiments and/or dispositions can be used to select dialogue forms. For example, and without imputing limitation, dialogue forms can be generally categorized as forms for sentiment-based dialogue and forms for objective-based dialogue. Sentiment-based dialogue forms can include rules, lexicons, styles, and the like for engaging in dialogue (e.g., presenting to) particular sentiments. Likewise, objective-based dialogue forms may include rules, lexicons, styles, and the like for engaging in dialogue in order to achieve certain specified objectives (e.g., persuade, inform, etc.). Further, multiple dialogue forms can be selected and exert more or less influence based on respective sentiment and/or objectives or corresponding weights and the like.

Selected dialogue forms may be used to provide dialogue guidance one or more users (e.g., speakers or participants). For example, dialogue guidance may include restrictions (e.g., words, phrases, metaphors, arguments, references, and such that should not be used), suggestions (e.g., words, phrases, metaphors, arguments, references, and such that should be used), or other guidance. Dialogue forms may include, for example and without imputing limitation, persuasion, negotiation, inquiry, deliberation, information seeking, Eristics, and others.

In some examples, dialogue forms may also include evidence standards. For example, persuasive form may be associated with a heightened standard of evidence. At the same time, certain detected sentiments or dispositions may be associated with particular standards of evidence or source preferences. For example, a dialogue participant employed in a highly technical domain, such as an engineer or the like, may be disposed towards (e.g., find more persuasive) sources associated with a particular credential (e.g., a professor from an alma mater), a particular domain (e.g., an electrical engineering textbook), a particular domain source (e.g., an IEEE publication), and the like. In some examples, a disposition or sentiment may be associated with heightened receptiveness to particular cultural references and the like. Further, in cases where multiple dialogue forms interact or otherwise are simultaneously active (e.g., where a speaker is attempting to persuade an audience determined by the sentiment identification system to be disposed towards believing the speaker), an evidence standard based on both these forms may be suggested to the speaker.

Likewise, dialogue forms may also include premise interrelationship standards. For example, threshold values, empirical support, substantiation, and other characteristics of premise interrelationships may be included in dialogue forms. The premise interrelationship standards can be included directly within or associated with dialogue forms as rules, or may be included in a probabilistic fashion (e.g., increasing likelihoods of standards, etc.), or via some combination of the two.

Dialogue forms can also include burden of proof standards. For example, and without imputing limitation, null hypothesis requirements, references to tradition, “common sense”, principles based on parsimony and/or complexity, popularity appeals, default reasoning, extension and/or abstractions of chains of reasoning (in some examples, including ratings and such), probabilistic falsification, pre-requisite premises, and other rules and/or standards related to burden of proof may be included in or be associated with particular dialogue forms.

Once one or more dialogue forms have been selected based on identified sentiment and/or disposition, the forms can be presented to a user (e.g., a speaker) via a user device or some such. In some examples, the dialogue forms can be applied to preexisting information such as a written speech and the like. The dialogue forms can also enable strategy and/or coaching of the user.

The customized media content delivery engine 335 can deliver the customized media content (that is generated by the customized media content constructor 330) to the user device 105 of the user 325 using content delivery options preferred by user 325. The content delivery options preferred by user 325 may be determined based on the analysis 320 of the user 325.

The customized media content constructor 330 of FIG. 3 may be an example of the customized media content constructor 140 of FIG. 1. The customized media content delivery engine 335 of FIG. 3 may be an example of the customized media content delivery engine 142 of FIG. 1.

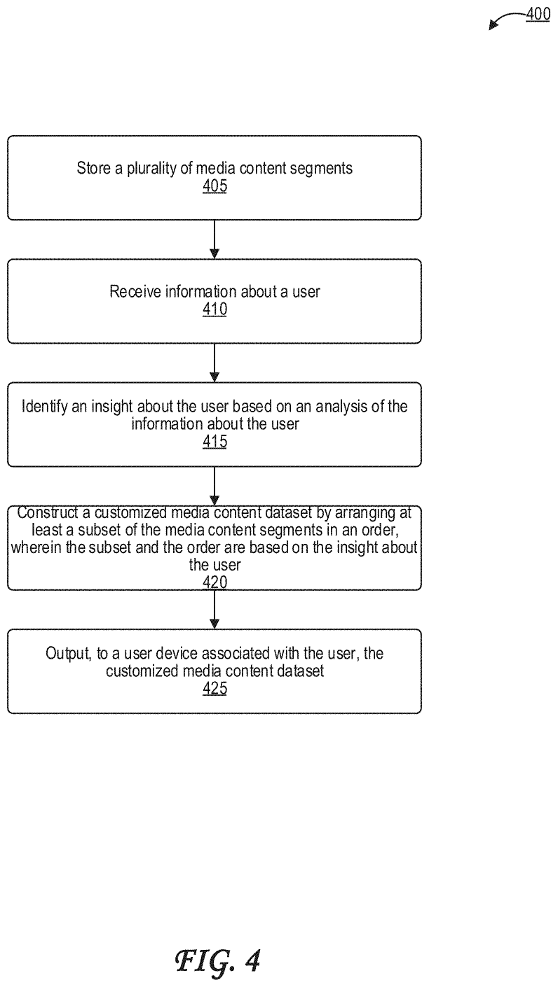

FIG. 4 is a flow diagram illustrating a process 400 for automated constructing and outputting a customized media dataset based on an insight about a user. The process 400 may be performed a media system. The media system may be, or may include, at least one of: the media control system 100, the user device 105, the interface layer 110, the application layer 130, the infrastructure layer 160, the customized media content constructor 140, the customized media content constructor 330, the customized media content delivery engine 142, the customized media content delivery engine 335, the computing system 600, an apparatus, a system, a memory storing instructions to be executed using a processor, a non-transitory computer readable storage medium having embodied thereon a program to be executed using a processor, another device or system described herein, or a combination thereof.

At operation 405, the media system stores a plurality of media content segments. Examples of the plurality of media content segments of operation 405 include the media content segments 205A-205J of FIG. 2 and the media content segments 315A-315Z of FIG. 3. The storage of the media content segments 305 in the data storage 310 of FIG. 3 is an example of the storage of the plurality of media content segments of operation 405. Operation 505 may correspond to operation 405.

At operation 410, the media system receives information about a user. The information about the user may be received from a user device associated with the user, such as the user device 105. The information about the user may be received through an interface layer 110. Operation 515 may correspond to operation 410.

At operation 415, the media system identifies an insight about the user based on an analysis of the information about the user. Examples of the analysis of the information about the user of operation 415 include the analysis 320 of the user 325 of FIG. 3, the determinations 210A-210D of FIG. 2, and the various analyses and insights discussed as performed by the user analysis engine 134. Operation 520 may correspond to operation 415.

At operation 420, the media system constructs a customized media content dataset by arranging at least a subset of the media content segments in an order. The subset and the order are based on the insight about the user. The construction of the customized media content dataset of FIG. 2 out of a subset of the media content segments 210A-210J selected based on the determinations 210A-210D and arranged in an order based on the determinations 210A-210D may be an example of the construction of the customized media content dataset of operation 420. Other examples of the construction of the customized media content dataset of operation 420 are discussed with respect to the customized media content constructor 140 of FIG. 1, the customized media content delivery engine 142 of FIG. 1, the customized media content constructor 330 of FIG. 3, and the customized media content delivery engine 335 of FIG. 3. Operation 525 may correspond to operation 420.

At operation 425, the media system outputs, to a user device associated with the user, the customized media content dataset. Outputting the customized media content dataset can include playing the customized media content dataset on the user device. Outputting the customized media content dataset can include sending the customized media content dataset to the user device. Outputting the customized media content dataset can include streaming the customized media content dataset to the user device. In some examples, output of the customized media content dataset at operation 425 may be customized by the media system based on the information about the user and/or based on the insights as discussed with respect to the customized media content delivery engine 142 and/or the customized media content delivery engine 335. Operations 510 and 530 may correspond to operation 425. For instance, the customized media content dataset of operations 420-425 can include the first media content segment of operation 510 followed by the second media content dataset of operations 525-530.

In some examples, the plurality of media content segments include a plurality of video segments, a plurality of text segments, a plurality of audio segments, a plurality of images, a plurality of slideshow slides, or a combination thereof. In some examples, the customized media content dataset includes video content, text content, audio content, image content, slideshow content, or a combination thereof.

In some examples, outputting the customized media content dataset includes outputting a first media content segment (e.g., as in operation 510 of the process 500) and outputting a second media content segment after outputting the first media content segment (e.g., as in operation 530 of the process 500). In some examples, constructing the customized media content dataset by arranging at least the subset of the plurality of media content segments in the order as in operation 420 includes selecting the second media content segment (e.g., as in operation 525 of the process 500). In some examples, at least some of the information about the user is received while the first media content segment is output to the user device, and the insight about the user relates to a reaction of the user to output of the first media content segment through the user device.

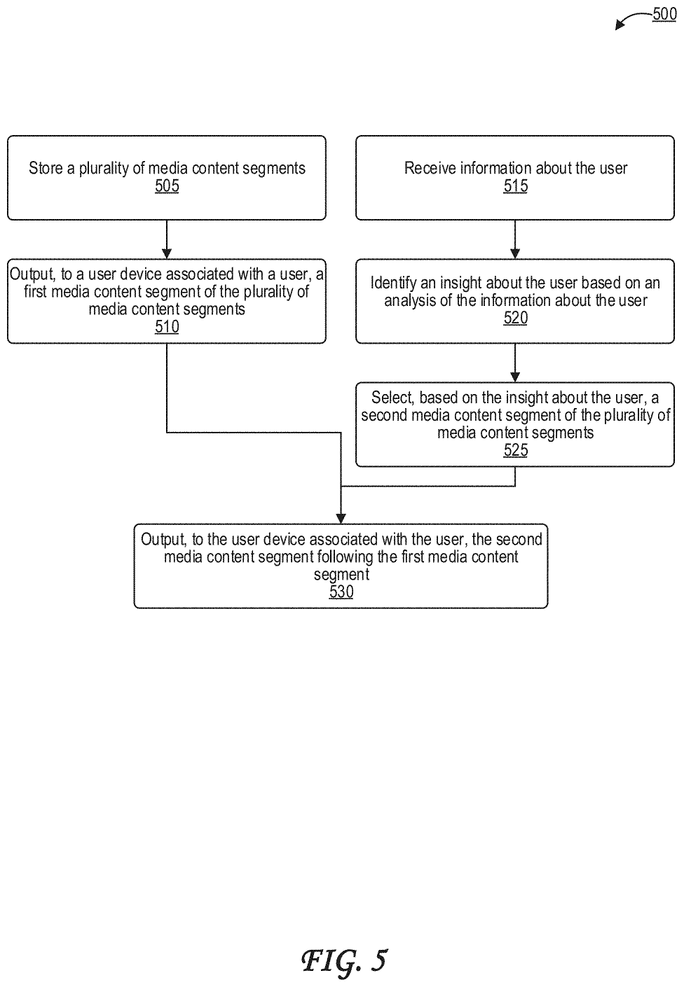

FIG. 5 is a flow diagram illustrating a process 500 for automated customized outputting media content segments based on an insight about a user. The process 500 may be performed a media system. The media system may be, or may include, at least one of: the media control system 100, the user device 105, the interface layer 110, the application layer 130, the infrastructure layer 160, the customized media content constructor 140, the customized media content constructor 330, the customized media content delivery engine 142, the customized media content delivery engine 335, the computing system 600, an apparatus, a system, a memory storing instructions to be executed using a processor, a non-transitory computer readable storage medium having embodied thereon a program to be executed using a processor, another device or system described herein, or a combination thereof.

At operation 505, the media system stores a plurality of media content segments. Examples of the plurality of media content segments of operation 505 include the media content segments 205A-205J of FIG. 2 and the media content segments 315A-315Z of FIG. 3. The storage of the media content segments 305 in the data storage 310 of FIG. 3 is an example of the storage of the plurality of media content segments of operation 505. Operation 405 may correspond to operation 505. In some examples, the plurality of media content segments include a plurality of video segments, a plurality of text segments, a plurality of audio segments, a plurality of images, a plurality of slides (e.g., of a slide show or slide deck), or a combination thereof.

At operation 510, the media system outputs, to a user device associated with a user, a first media content segment of the plurality of media content segments. Outputting the first media content segment can include playing the first media content segment on the user device. Outputting the first media content segment can include sending the first media content segment to the user device. In some examples, output of the first media content segment at operation 510 may be customized by the media system based on the information about the user and/or based on the insights as discussed with respect to the customized media content delivery engine 142 and/or the customized media content delivery engine 335. Outputting the first media content segment can include streaming the first media content segment to the user device. Operations 415 may correspond to operation 510.

At operation 515, the media system receives information about the user. The information about the user may be received from a user device associated with the user, such as the user device 105. The information about the user may be received through an interface layer 110. Examples of the information include information received through the interface layer 110, such as demographic information about the user, one or more sentiments of the user, social network connections of the user, beliefs of the user, interactions between the user and content interfaces, historical data about the user, a reputation of the user, body language of the user, expressed reactions of the user, information about other users, information about similar users to the user, or combinations thereof. Operation 410 may correspond to operation 515. In some examples, receipt of at least a portion of the information about the user occurs while the first media content segment is being output to the user device.

At operation 520, the media system identifies an insight about the user based on an analysis of the information about the user. Examples of the analysis of the information about the user of operation 520 include the analysis 320 of the user 325 of FIG. 3, the determinations 210A-210D of FIG. 2, and the various analyses and insights discussed as performed by the user analysis engine 134. Examples of the insight include insights produced by any of the elements of the user analysis engine 134, insights produced by any of the elements of the application layer 130, the any of the determinations 210A-210D, insights produced by the analysis 320 of the user 325, the insight of operation 415, or a combination thereof. The insight can be an insight about, for instance, demographic information about the user, one or more sentiments of the user, social network connections of the user, beliefs of the user, interactions between the user and content interfaces, historical data about the user, a reputation of the user, body language of the user, expressed reactions of the user, information about other users, information about similar users to the user, or combinations thereof. Operation 415 may correspond to operation 520.

In some examples, at least some of the information about the user is received while the first media content segment is output to the user device, and the insight about the user relates to a reaction of the user to output of the first media content segment through the user device. For example, the insight of determination 210B can indicate whether the user's reaction to the previous media content segments 205A-205C is to be upset, and the insight of determination 210C can indicate whether the user's reaction to the previous media content segments 205A-205E is to be in a hurry (e.g., to want to hurry things along).

In some examples, the analysis of the information about the user to identify the insight about the user occurs while the first media content segment is being output to the user device. In some examples, analysis of the information while the first media content segment is being output allows the analysis to occur in real-time or near real-time as information is being received. In some examples, analysis of the information while the first media content segment is being output allows the analysis to be based on information received while the user is consuming the first media content segment.

In some examples, identifying the insight about the user based on the analysis of the information about the user includes providing the information about the user as an input to one or more trained machine learning (ML) models that output the insight about the user in response to input of the information about the user. The trained ML model(s) can include, for example, one or more neural network (NNs), one or more convolutional neural networks (CNNs), one or more trained time delay neural networks (TDNNs), one or more deep networks, one or more autoencoders, one or more deep belief nets (DBNs), one or more recurrent neural networks (RNNs), one or more generative adversarial networks (GANs), one or more conditional generative adversarial networks (cGANs), one or more other types of neural networks, one or more trained support vector machines (SVMs), one or more trained random forests (RFs), one or more deep learning systems, or combinations thereof. The input(s) (e.g., the information about the user) may be received into one or more input layers of the trained ML model(s). The output (e.g., the insight about the user) may be output via one or more output layers of the trained ML model(s). The trained ML model(s) may include various hidden layer(s) between the input layer(s) and the output layer(s). The hidden layer(s) may be used to make various decisions and/or analyses that ultimately are used as bases for the insight about the user, such as determinations as to which pieces of information are more important than others (e.g., weighted higher or lower, biased higher or lower) for the determination of the insight, analyses using the user analysis engine 134, any of the determinations 210A-210D, the analysis 320 of the user 325, or a combination thereof. The trained ML model(s) may be trained using training data by the media system and/or another system. The training data can include, for example, pre-determined insights about a user along with corresponding information about the user.

At operation 525, the media system selects, based on the insight about the user, a second media content segment of the plurality of media content segments. The selection of the second media content segment of operation 525 may be a selection of the second media content segment to be output after the first media content segment (in operation 530). Examples of selection of the second media content segment (to be output after the first media content segment) of operation 525 can include selections of which of the media content segments 210A-210J of FIG. 2 to output next based on each of the determinations 210A-210D. Other examples of the selection of the second media content segment (to be output after the first media content segment) of operation 525 are discussed with respect to the customized media content constructor 140 of FIG. 1, the customized media content delivery engine 142 of FIG. 1, the customized media content constructor 330 of FIG. 3, and the customized media content delivery engine 335 of FIG. 3. Operation 420 may correspond to operation 525.

In some examples, selection of the second media content segment occurs while the first media content segment is being output to the user device. In some examples, selection of the second media content segment while the first media content segment is being output allows the selection can be made in real-time or near real-time as information is being received and/or insights are being generated. In some examples, selection of the second media content segment while the first media content segment is being output allows the selection to be based on information received while the user is consuming the first media content segment and/or insights as to the user's reactions to consuming the first media content segment.

In some examples, selecting the second media content segment based on the insight about the user includes providing the information about the user and/or the insight about the user as input(s) to one or more trained machine learning models that output an indicator of the second media content segment in response to the input(s). The indicator may identify the second media content segment to be selected. The trained ML model(s) can include, for example, one or more NNs, one or more CNNs, one or more TDNNs, one or more deep networks, one or more autoencoders, one or more DBNs, one or more RNNs, one or more GANs, one or more cGANs, one or more trained SVMs, one or more trained RFs, one or more deep learning systems, or combinations thereof. The input(s) (e.g., the information about the user and/or the insight about the user) may be received into one or more input layers of the trained ML model(s). The output (e.g., the indicator of the second media content segment to be selected) may be output via one or more output layers of the trained ML model(s). The trained ML model(s) may include various hidden layer(s) between the input layer(s) and the output layer(s). The hidden layer(s) may be used to make various decisions and/or analyses that ultimately are used as bases for the selection of the second media content segment, such as determinations as to which information and/or insights are more important than others (e.g., weighted higher or lower, biased higher or lower) for the selection of the second media content segment, analyses using the user analysis engine 134, any of the determinations 210A-210D, the analysis 320 of the user 325, or a combination thereof. The trained ML model(s) may be trained using training data by the media system and/or another system. The training data can include, for example, pre-determined selections of second media content segments, along with corresponding information about a user and/or the insight about the user.

At operation 530, the media system outputs, to the user device associated with the user, the second media content segment following the first media content segment. Outputting the second media content segment can include playing the second media content segment on the user device. Outputting the second media content segment can include sending the second media content segment to the user device. Outputting the second media content segment can include streaming the second media content segment to the user device. In some examples, output of the second media content segment at operation 530 may be customized by the media system based on the information about the user and/or based on the insights as discussed with respect to the customized media content delivery engine 142 and/or the customized media content delivery engine 335. Operations 415 may correspond to operation 530. For instance, the customized media content dataset of operations 420-425 can include the first media content segment of operation 510 followed by the second media content dataset of operations 525-530.

In some examples, selection of the second media content segment of operation 525 occurs while the first media content segment is being output to the user device at operation 510. In some examples, receipt of the information about the user of operation 515 occurs while the first media content segment is being output to the user device at operation 510. In some examples, analysis of the information about the user to identify the insight about the user of operation 520 occurs while the first media content segment is being output to the user device at operation 510. For example, the user may express a reaction to the first media content segment, express a sentiment while the first media content segment is being output, perform an interaction while the first media content segment is being output, perform a specific body language expression while the first media content segment is being output, or a combination thereof. Based on such user information and/or insights, the media system can select the second media content segment.

In some examples, selection of the second media content segment of operation 525 occurs before the first media content segment is being output to the user device at operation 510. In some examples, receipt of the information about the user of operation 515 occurs before the first media content segment is being output to the user device at operation 510. In some examples, analysis of the information about the user to identify the insight about the user of operation 520 occurs before the first media content segment is being output to the user device at operation 510. For example, the user may express a reaction to the first media content segment, express a sentiment before the first media content segment is output, perform an interaction before the first media content segment is output, perform a specific body language expression before the first media content segment is output, or a combination thereof. Based on such user information and/or insights, the media system can select the second media content segment.

In some examples, selection of the second media content segment of operation 525 occurs after the first media content segment is being output to the user device at operation 510. In some examples, receipt of the information about the user of operation 515 occurs after the first media content segment is being output to the user device at operation 510. In some examples, analysis of the information about the user to identify the insight about the user of operation 520 occurs after the first media content segment is being output to the user device at operation 510. For example, the user may express a reaction to the first media content segment, express a sentiment after the first media content segment is output, perform an interaction after the first media content segment is output, perform a specific body language expression after the first media content segment is output, or a combination thereof. Based on such user information and/or insights, the media system can select the second media content segment.

In some examples, selecting the second media content segment based on the insight (as in operation 525) and outputting the second media content segment following the first media content segment (as in operation 530) includes bypassing a third media content segment of the plurality of media content segments from a previously determined media content arrangement. In the previously determined media content arrangement, the third media content segment is between the first media content segment and the second media content segment. For example, in the context of FIG. 2, the media content segment 205A is an example of the first media content segment, the media content segment 205C is an example of the second media content segment, and the media content segment 205B is an example of the third media content segment that is bypassed based on the determination 210A. In the context of FIG. 2, the previously determined media content arrangement can be, in order, media content segment 205A (the first media content segment), media content segment 205B (the third media content segment), and media content segment 205C (the second media content segment). Other examples include bypassing of one or more of the media content segments 205D-205J based on one or more of the determinations 210B-210D.

In some examples, selecting the second media content segment based on the insight (as in operation 525) and outputting the second media content segment following the first media content segment (as in operation 53) includes inserting the second media content segment in between the first media content segment and a third media content segment of the plurality of media content segments from a previously determined media content arrangement. In the previously determined media content arrangement, the third media content segment follows the first media content segment in the previously determined media content arrangement. For example, in the context of FIG. 2, the media content segment 205A is an example of the first media content segment, the media content segment 205C is an example of the second media content segment, and the media content segment 205B is an example of the third media content segment that is inserted in between the other two media content segments based on the determination 210A. In the context of FIG. 2, the previously determined media content arrangement can be, in order, media content segment 205A (the first media content segment) and media content segment 205C (the second media content segment). Other examples include inserting of one or more of the media content segments 205D-205J based on one or more of the determinations 210B-210D.

In some examples, the media system modifies, based on the insight about the user, at least one of the second media content segment or the first media content segment, including by replacing at least a first phrase with a second phrase. In some examples, the replacement of the first phrase and the second phrase can include replacing a first idiom with a second idiom that the insight about the user indicates the user is likely to be more receptive to and/or that the user is more likely to understand. In some examples, the replacement of the first phrase and the second phrase can include replacing a first example with a second example that the insight about the user indicates the user is likely to be more receptive to and/or that the user is more likely to understand. In some examples, the replacement of the first phrase and the second phrase can include replacing a first slang phrase with a second slang phrase that the insight about the user indicates the user is likely to be more receptive to and/or that the user is more likely to understand.

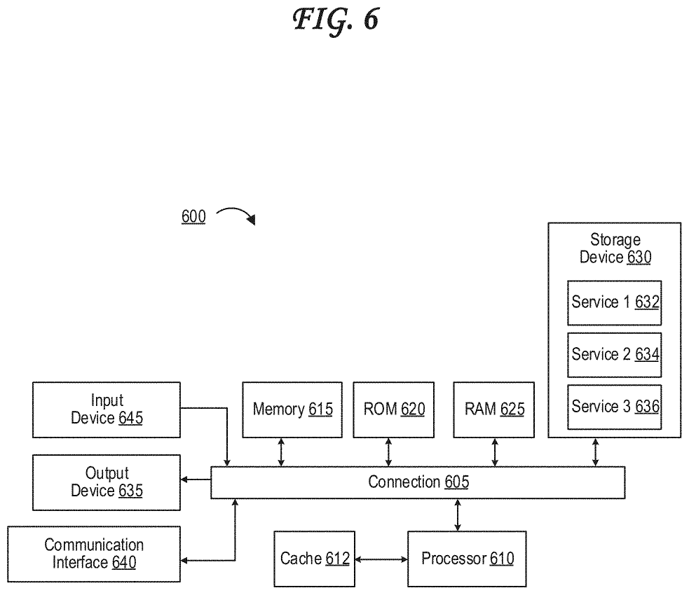

FIG. 6 is a diagram illustrating an example of a system for implementing certain aspects of the present technology. In particular, FIG. 6 illustrates an example of computing system 600, which can be for example any computing device or computing system making up the an internal computing system, a remote computing system, or any combination thereof. The components of the system are in communication with each other using connection 605. Connection 605 can be a physical connection using a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (CPU or processor) 610 and connection 605 that couples various system components including system memory 615, such as read-only memory (ROM) 620 and random access memory (RAM) 625 to processor 610. Computing system 600 can include a cache 612 of high-speed memory connected directly with, in close proximity to, or integrated as part of processor 610.

Processor 610 can include any general purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 602.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 630 can include software services, servers, services, etc., that when the code that defines such software is executed by the processor 610, it causes the system to perform a function. In some embodiments, a hardware service that performs a particular function can include the software component stored in a computer-readable medium in connection with the necessary hardware components, such as processor 610, connection 605, output device 635, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

What is claimed is:

1. A method of automated media content customization, the method comprising:
storing a plurality of media content segments;
receiving information about a user;
identifying an insight about the user based on an analysis of the information about the user;
constructing a customized media content dataset by arranging at least a subset of the plurality of media content segments in an order, wherein the subset and the order are based on the insight about the user; and
outputting, to a user device associated with the user, the customized media content dataset.

2. The method of claim 1, wherein outputting the customized media content dataset includes outputting a first media content segment and outputting a second media content segment after outputting the first media content segment, wherein constructing the customized media content dataset by arranging at least the subset of the plurality of media content segments in the order includes selecting the second media content segment.

3. The method of claim 2, wherein at least some of the information about the user is received while the first media content segment is output to the user device, wherein the insight about the user relates to a reaction of the user to output of the first media content segment through the user device.

4. A method of automated media content customization, the method comprising:
storing a plurality of media content segments;
outputting, to a user device associated with a user, a first media content segment of the plurality of media content segments;
receiving information about the user;
identifying an insight about the user based on an analysis of the information about the user;
selecting, based on the insight about the user, a second media content segment of the plurality of media content segments; and
outputting, to the user device associated with the user, the second media content segment following the first media content segment.

5. The method of claim 4, wherein selection of the second media content segment occurs while the first media content segment is being output to the user device.

6. The method of claim 4, wherein at least some of the information about the user is received while the first media content segment is output to the user device, and wherein the insight about the user relates to a reaction of the user to output of the first media content segment through the user device.

7. The method of claim 4, wherein the analysis of the information about the user to identify the insight about the user occurs while the first media content segment is being output to the user device.

8. The method of claim 4, wherein the plurality of media content segments includes at least one of a plurality of video segments, a plurality of text segments, a plurality of audio segments, a plurality of images, or a plurality of slides.

9. The method of claim 4, wherein selecting the second media content segment based on the insight and outputting the second media content segment following the first media content segment includes bypassing a third media content segment of the plurality of media content segments from a previously determined media content arrangement, wherein the third media content segment is between the first media content segment and the second media content segment in the previously determined media content arrangement.

10. The method of claim 4, wherein selecting the second media content segment based on the insight and outputting the second media content segment following the first media content segment includes inserting the second media content segment in between the first media content segment and a third media content segment of the plurality of media content segments from a previously determined media content arrangement, wherein the third media content segment follows the first media content segment in the previously determined media content arrangement.

11. The method of claim 4, further comprising:
modifying, based on the insight about the user, at least one of the second media content segment or the first media content segment, including by replacing at least a first phrase with a second phrase.

12. The method of claim 4, wherein identifying the insight about the user based on the analysis of the information about the user includes providing the information about the user as an input to one or more trained machine learning models that output the insight about the user in response to input of the information about the user.

13. The method of claim 4, wherein selecting the second media content segment based on the insight about the user includes providing the insight about the user as an input to one or more trained machine learning models that output an indicator of the second media content segment in response to input of the insight about the user.

14. A system for automated media content customization, the system comprising:
a data store that stores a plurality of media content segments;
a memory storing instructions; and
a processor that executes the instructions, wherein execution of the instructions causes the processor to:
output, to a user device associated with a user, a first media content segment of the plurality of media content segments;
receive information about the user;
identify an insight about the user based on an analysis of the information about the user;
select, based on the insight about the user, a second media content segment of the plurality of media content segments; and
output, to the user device associated with the user, the second media content segment following the first media content segment.

15. The system of claim 14, wherein at least some of the information about the user is received while the first media content segment is output to the user device, and wherein the insight about the user relates to a reaction of the user to output of the first media content segment through the user device.

16. The system of claim 14, wherein selecting the second media content segment based on the insight and outputting the second media content segment following the first media content segment includes bypassing a third media content segment of the plurality of media content segments from a previously determined media content arrangement, wherein the third media content segment is between the first media content segment and the second media content segment in the previously determined media content arrangement.

17. The system of claim 14, wherein selecting the second media content segment based on the insight and outputting the second media content segment following the first media content segment includes inserting the second media content segment in between the first media content segment and a third media content segment of the plurality of media content segments from a previously determined media content arrangement, wherein the third media content segment follows the first media content segment in the previously determined media content arrangement.

18. The system of claim 14, wherein execution of the instructions causes the processor to further:
modify, based on the insight about the user, at least one of the second media content segment or the first media content segment, including by replacing at least a first phrase with a second phrase.

19. The system of claim 14, wherein identifying the insight about the user based on the analysis of the information about the user includes providing the information about the user as an input to one or more trained machine learning models that output the insight about the user in response to input of the information about the user.

20. The system of claim 14, wherein selecting the second media content segment based on the insight about the user includes providing the insight about the user as an input to or more trained machine learning models that output an indicator of the second media content segment in response to input of the insight about the user.
